(19) United States
(12) Patent Application Publication
(10) Pub. No.: US 2020/0234276 A1
(43) Pub. Date: Jul. 23, 2020

(54) TRANSPORTATION VEHICLE AUDIBLE TRANSACTIONAL SECURITY AUTHENTICATION

(71) Applicants: VOLKSWAGEN AKTIENGESELLSCHAFT, Wolfsburg (DE); PORSCHE AG, Stuttgart (DE); AUDI AG, Ingolstadt (DE)

(72) Inventors: Benedict A. RECKTENWALD, Sunnyvale, CA (US); Ian KENDALL, San Mateo, CA (US)

(21) Appl. No.: 16/254,706

(22) Filed: Jan. 23, 2019

(51) Int. Cl. G06Q 20/32; G06Q 20/38; H04W 4/44; H04B 11/00; H04L 29/06

(52) U.S. Cl. CPC G06Q 20/3272; G06Q 20/3825; B60R 11/0247; H04B 11/00; H04L 63/123; H04W 4/44

(57) ABSTRACT

Devices, systems, and methodologies for transportation vehicle communications using sound devices to communicate embedded communication signals with other infrastructure. A communication system may communicate with the sound devices to provide communication signals.

### FIELD

Disclosed embodiments related to devices, systems, and methodologies of transportation vehicles. In particular, the presently disclosed embodiments relates to devices, systems, and methodologies for transportation vehicle communications.

### SUMMARY

In accordance with illustrative embodiments, a transportation vehicle may include a communication system and sound generator for providing communication with infrastructure via acoustic signals.

In accordance with illustrative embodiments, a transportation vehicle for secure communications may comprise a vehicle chassis, a communication system including a processor and a memory device, the processor executing instructions stored on the memory device to provide communication commands based on the executed instructions, and a noise generation means for providing an audible noise signal as an alert that the transportation vehicle is near. The audible noise signal may include embedded communications based on the communication commands from the communication system. The embedded communications may include a token having a signature to enable verification that the token remains unaltered.

In accordance with illustrative embodiments, the token may include a payload for communication to one or more infrastructure devices. The payload may include payment information. The token may be encrypted to conceal the payload from unauthorized access.

In accordance with illustrative embodiments, the noise generation means may include a speaker for providing an audible noise. The speaker may be a quiet mode device for providing constant audible noise during operation of the transportation vehicle in quiet modes.

In accordance with illustrative embodiments, the noise generation means includes a sound receiver for receiving acoustic signals. The sound receiver may receive inbound acoustic signals from one or more infrastructure devices. The sound received my communicate the inbound acoustic signals to the communication system. The sound receiver may include a microphone.

### BRIEF DESCRIPTION OF THE FIGURES

The detailed description particularly refers to the accompanying figures in which:

FIG. 1 is a perspective view of a transportation vehicle including a communications system and a noise generation device generating audible noise signals;

FIG. 2 is a plan view of the transportation vehicle of FIG. 1 showing that the noise generation device is adapted to provide an audible warning of the presence of the transportation vehicle and to communicate with a gate for access;

FIG. 3 is a diagrammatic view of the communication system in communication with infrastructure via the noise generation device;

FIG. 4 is a diagrammatic view of operations of the communication system showing that communication system performs communication and/or auxiliary operations and security operations, and generates a command for the noise generation device; and

FIG. 5 is a flow diagram indicating a security operation of the communication system.

### DETAILED DESCRIPTION

The figures and descriptions provided herein may have been simplified to illustrate aspects that are relevant for a clear understanding of the herein described devices, systems, and methods, while eliminating, for the purpose of clarity, other aspects that may be found in typical devices, systems, and methods. Those of ordinary skill may recognize that other elements and/or operations may be desirable and/or necessary to implement the devices, systems, and methods described herein. Because such elements and operations are well known in the art, and because they do not facilitate a better understanding of the presently disclosed embodiments, a discussion of such elements and operations may not be provided herein. However, the presently disclosed embodiments are deemed to inherently include all such elements, variations, and modifications to the described aspects that would be known to those of ordinary skill in the art.

Advances in the incorporated technology of transportation vehicles can improve the transportation experience and/or safety. As transportation vehicle technology advances, for example, in the realm of autonomous and/or semi-autonomous transportation vehicles, communications between the transportation vehicle itself and other infrastructure can improve the transportation experience and/or safety. For example, communication between the transportation vehicle and infrastructure such as roadway elements (e.g., traffic lights, signs, traffic control information servers, fuel/charging stations, etc.), other vehicles, and/or other fixed infrastructure elements (e.g., gates, garage doors, etc.) can enhance the transportation experience and/or safety. Moreover, the number, arrangement, and/or type of onboard devices and/or systems to support the technology can face challenges as transportation vehicle technology advances. Expanding the versatility of onboard systems can increase the value and/or effectiveness of the incorporated technology.

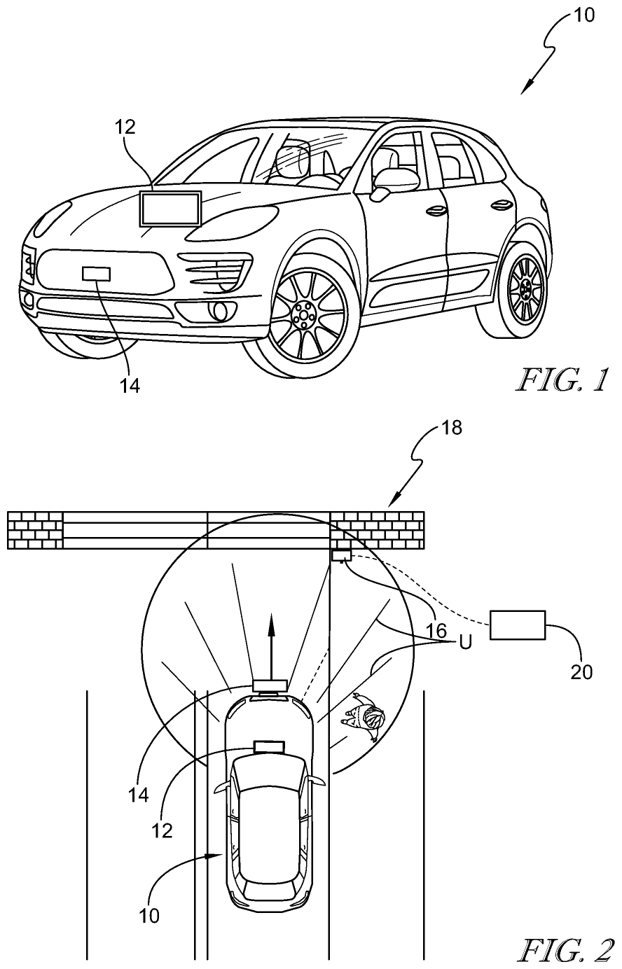

Referring to FIG. 1, a transportation vehicle 10 is shown which may include a communication system 12 for conducting communications between the transportation vehicle 10 and other infrastructure. The transportation vehicle 10 may include a sound generator 14 for communicating signals as directed by the communication system 12. The sound generator 14 may be arranged on the front of the vehicle chassis, for example, in the hood compartment, to provide sound signals to infrastructure outside the transportation vehicle 10, although in some embodiments, the sound generator 14 may be arranged on any suitable portion of the vehicle chassis.

Referring to FIG. 2, the sound generator 14 may form sound generation means for providing an audible noise signal. The audible noise signal can include embedded communications for communication with infrastructure. For example, the audible noise signal may include digital communications, the substance of which is not identifiable to the human ear embedded within the audible signal.

The audible noise signal may be formed as a continuously audible sound intentionally generated by the transportation vehicle 10. Modern transportation vehicles may operate in quite modes, for example, modes in which electrical power is the primary source of drive with reduction or elimination of internal combustion engine operations. Such quiet modes may incur hazards in which the presence of the transportation vehicle cannot be heard, eliminating a sensory indication of the transportation vehicle's presence. One solution to the hazards of such quiet modes is to intentionally generate artificial sound to alert those nearby to the presence of the transportation vehicle. Indeed, in some jurisdictions, such “e-sounds” may be required.

In illustrative embodiments, the sound generator 14 may be formed as a noise generation device for providing intentionally audible noise during operation of the transportation vehicle 10 in quiet modes. The sound generator 14 may generate sound signals in the acoustic range, for example, within the range of about 20 Hz to about 20 kHz, although frequencies above about 20 kHz and/or below about 20 Hz may be applied as acoustic in some embodiments. By communicating embedded information within the audible signals, secure information communications can occur while reducing additional hardware requirements. For example, using audible signals can require the receiving entity to be within a limited physical distance, reducing the opportunity for unintended communications.

As suggested in FIG. 2, the sound generator 14 may produce audible noise signals U, embodied as vehicle-presence alert noise. The signals U can reach the general proximity of the transportation vehicle 10 to indicate its presence, for example, to pedestrian A in the vicinity of the transportation vehicle 10. The audible noise signals U can alert pedestrian A to the presence of the transportation vehicle 10. As previously mentioned, the signals U may contain embedded communications for communication with infrastructure.

As shown in FIG. 2, the audible noise signals U may communicate with communication device 16 of infrastructure. In illustrative embodiments, the infrastructure may be a gate 18 of a paid parking area and the communication device 16 may communicate to operate the gate 18 for entry of authorized transportation vehicles. The communications device 16 may be embodied as a wireless communications device of any manner of infrastructure communication system for receiving and processing the embedded communications signal of the audible noise signal U. For example, the communications device 16, may communicate to authorize entry, to identify the transportation vehicle, and/or as a payment terminal.

In the illustrative embodiment, the communications device 16 may be a payment terminal for executing payment transactions and opening the gate for paid parking. In other embodiments, the communications device 16 may be arranged for any other suitable activity which receives payment information indicated within the embedded communications signal, for example, fuel and/or electric charging, access to paid areas such as tolls roads, and/or drive thru services. The communications device 16 may itself process communications, such as payment transactions, from the transportation vehicle and/or may be arranged in communication with a remote server 20 for processing, such as to verify payment transactions. The communications device 16 may include processors, memory, and communications circuitry for performing its described operations. The communications device 16 may itself process communications, such as payment transactions, from the transportation vehicle 10 and/or may be arranged in communication with a remote server 20 for processing, such as to verify payment transactions.

The use of sound generators for communications between the transportation vehicle and other infrastructure can provide localized security. For example, the directional nature of the relatively local transmission of the sound, for example, within the range of about zero feet to about 50 feet, can avoid unintended communications. Still further, communication using the sounds generator 14 arranged for providing the audible noise alert of the presence of the transportation vehicle 10 can reduce the need for additional hardware dedicated to communications, reducing the spatial needs and related design requirements of the incorporated technology.

The embedded communication signals may include additional security features. For example, the embedded communication signals may include token-based authentication. The embedded communication signals may include a token having a header, payload, and signature. The signature can enable verification that the token remains unaltered from its state at origination. The token may be encrypted to conceal information against unauthorized access.

Continuing from the earlier example of payment transactions, an indication of payer's payment information may be encrypted and sent as part of the payload of the token from the transportation vehicle 10 to the communications device 16. The communications device 16 may verify the payment information by accessing the encrypted token via decryption tools. For example, the communications device 16 may include decryption tools and/or access decryption tools via the remote server 20. Accordingly, a secure payment transaction can occur between the transportation vehicle 10 and the infrastructure. In practice, the secure payment transaction can be embodied as payment for access such as parking, entry to secure spaces such as toll roadways, fuel/charging, and/or any other payment transaction. Secure communications is not limited to payment communications but may include any suitable communication type, for example, secure communication for identification to access secure physical sites through a security barrier such as a gate, and/or secure communication of navigational intent between the transportation vehicle 10 and other vehicles and/or traffic devices (traffic control, information, and/or entertainment devices) on roadways.

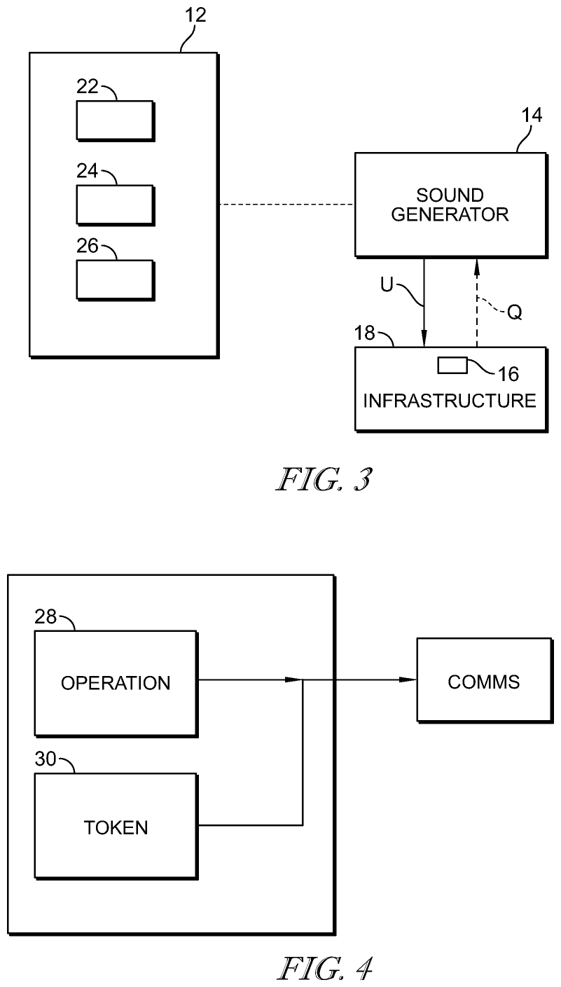

Referring to FIG. 3, the communication system 12 may perform communications operations. The communication system 12 may include a processor 22 for executing instructions stored on a memory device 24, and communications circuitry 26 for providing command signals to the sound generator 14 according to direction by the processor 22 based on the execution of the instructions. The communications circuitry 26 may be arranged for communication with other onboard devices and/or systems and/or personal mobile devices to receive user information such as payment information. The communication system 12 may store the relevant token and/or encryption information, for example, token and/or encryption algorithms, already known to the communications device 16 and/or remote server 20.

The communication system 12 may provide command signals to the sound generator 14 for generating the audible signals U for communication with the infrastructure. In addition to communications, the communication system 12 may provide processing operations to enable authorization such as payment authorization. In illustrative embodiments, the communications device 16 may provide communication signals Q to the transportation vehicle 10, which may be captured by a receiver (or transceiver) of the transportation vehicle 10 and processed by the communication system 12. The receiver may be formed as part of the sound generator 14, and may be formed as a microphone, although in some embodiments, may be formed distinctly from the sound generator 14. The communication signals Q may include confirmation and/or response information as an audible sound signal embedded with information, similar to the communication signals U, although some embodiments, the communication signals Q may have any suitable form for communication with the transportation vehicle 10. The communication signals Q may include a payment confirmation for receipt by the transportation vehicle 10. The communication signals Q may include token and/or encryption security similar to the signals U.

Referring to FIG. 4, a diagrammatic illustration of the operations of the communication system 12 indicates that the communication system 12 may provide diverse functionality. The communication system 12 may provide communications operations 28 which may include communication functions and/or other functions such as operations regarding the sounds such as the volume and/or style of noise applied to cause audible alert to the presence of the transportation vehicle 10. The communication system 12 may provide security operations 30 which may include token authentication and/or encryption operations. The communication system 12 may provide commands to the sound generator 14 to provide the communication signals U for the communication functions with the embedded communication signals for the communication functions including the token authenticated and/or encrypted information.

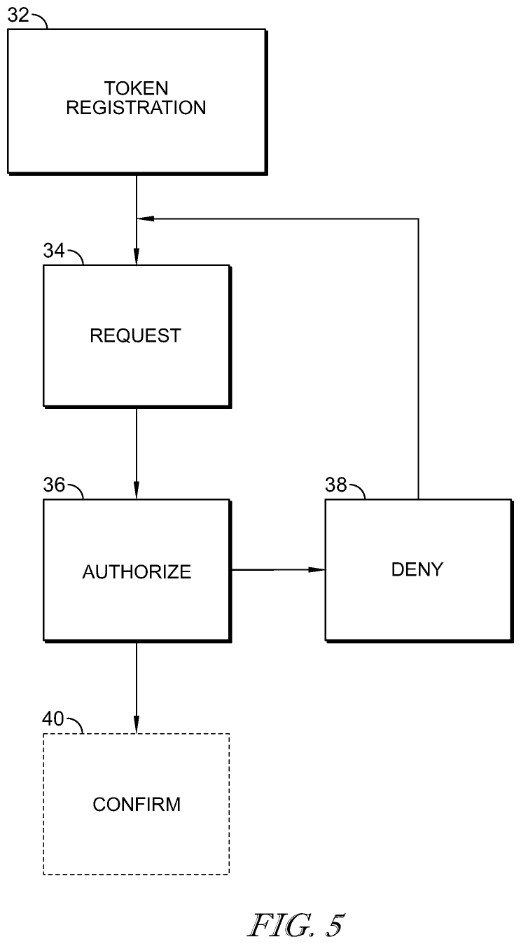

Referring to FIG. 5, a flow diagram of security operation is shown in which secure communications may be conducted. In box 32, token and/or encryption registration may be performed. The transportation vehicle 10 may perform the token and/or encryption registration. The registration may include registering an account and obtaining token and/or encryption information, such as token signature and/or encryption algorithms. The registration may be performed by independent communication with a central server, which may include and/or have communication with remote server 20 and/or communications device 16.

In box 34, a request may be made. Continuing from the earlier example of payment transactions, the request may be a request from the transportation vehicle 10 to the communications device 16 to execute payment. In some embodiments, the request may include an initial prompt and/or response, for example, the communications device 16 may initially prompt the transportation vehicle 10 for payment information. The request may include token authentication and/or encryption features.

In box 36, an authorization may be performed. The authorization may include determination that the request is valid such as by token authentication. Continuing from the earlier example of payment transactions, the authorization may include decryption as required, authentication of the token signature, and/or payment authentication and processing. In illustrative embodiments, the authorization may be performed by the communications device 16 responsive to the request for payment by the transportation vehicle, but in some embodiments, the transportation vehicle 10 may conduct authorization.

In response to a failed authorization in box 36, a denial may be performed in box 38. The denial may include denial of response, access, and/or other operations (e.g., payment) in response to the request of box 34. Continuing from the earlier example of payment transactions, the denial may include denial of payment. The denial may include a response indicating the denial, for example, in embodiments in which the communications device 16 performs the authorization, the communications device 16 may send an indication of denial to the transportation vehicle 10 upon failed authorization. An indication of denial may be presented to the user, for example, via a display screen of the transportation vehicle 10.

In response to successful authorization in box 36, optionally, a confirmation may be provided in box 40. The confirmation may include confirmation of response, access, and/or other operations (e.g., payment) in response to the successful authentication of box 34. The confirmation may include sending an indication of successful authorization. Continuing from the earlier example of payment transactions, the confirmation may include confirmation of successful payment. The confirmation may include sending a response indicating the successful payment, for example, in embodiments in which the communications device 16 performs the authorization, the communications device 16 may send an indication of successful payment to the transportation vehicle 10 upon successful authorization. An indication of confirmation may be presented to the user, for example, via a display screen of the transportation vehicle 10.

Vehicles that have the ability to drive in electrical modes, whether fully or partly, are often required to support some sort of exterior noise generation to warn people of the presence of a vehicle. The sounds required for electric vehicles, can be referred to as “esound.” Presently disclosed embodiments include applying this sound generation to include coded information that can be transferred within auditory range, and can subsequently be tuned to distance and noise requirements. Optionally, an exterior microphone may be included (for example, an exterior microphone for speech commands, such as a BlueGenie® product available from Sensory, Inc. of Santa Clara, Calif., USA for a voice recognition features) to receive communications from other infrastructure. Data may be communicated when the system is within range on an object that hears and returns a response/request for data. Technical solutions within the presently disclosed embodiments can provide a manner to communicate with infrastructure using existing speakers in a way that may provide enhanced security by enabling the system to optimize transfer volume to reduce the range of transmission, as well as using a method of communication not normally associated with data transfer. Moreover, the addition of an inexpensive microphone can provide exchange of communications.

Presently disclosed embodiments may include technical solutions for additional authentication and encryption security features can afford further protection against unintended access to information. Moreover, the potential for interference may be combatted with authentication and encryption security features, including but without limitation, interference at significant speeds of travel.

In presently disclosed embodiments, a communication system may provide secure communications between a transportation vehicle and infrastructure. The communication system may include a communication control system including a processor and a memory device, the processor executing instructions stored on the memory device to provide commands based on the executed instructions; and a sound generator for providing an audible noise signal as an alert that the transportation vehicle is near. The audible noise signal may include embedded communications based on the communication commands from the communication system. The embedded communications may include a token having a signature to enable verification that the token remains unaltered.

In presently disclosed embodiments, the token may include a payload for communication to one or more infrastructure devices. The payload may include payment information. The token may be encrypted to conceal the payload from unauthorized access.

In presently disclosed embodiments, the sound generator may include a speaker for providing an audible noise. The speaker may be formed as a quiet mode device for providing constant audible noise during operation of the transportation vehicle in quiet modes. The sound generator may include a sound receiver for receiving acoustic signals. The sound receiver may receive inbound acoustic signals from one or more infrastructure devices. The sound receiver may communicates the inbound acoustic signals to the communication system. The sound receiver may include a microphone.

In presently disclosed embodiments, a method of providing secure communication for a transportation vehicle which may include a vehicle chassis and a communication system may include a processor executing instructions stored on a memory device coupled thereto to provide communication commands based on the executed instructions; and the communication system generating one or more sound signals based on the communication commands using a sound generator. The one or more sound signals may include a token having a signature enabling verification that the token remains unaltered.

In presently disclosed embodiments, the token may include a payload for communication to one or more infrastructure devices. The payload may include payment information. The token may be encrypted to conceal the payload from unauthorized access.

In presently disclosed embodiments, the sound signals may include acoustic frequencies. The sound generator may be an e-sound device for providing an audible indication that the transportation vehicle is present. The sound generator may include a sound receiver for receiving sound signals. The sound receiver may receive inbound sound signals from one or more infrastructure devices. The sound receiver may communicate inbound sound signals to the communication system. The sound receiver may include a microphone.

Although certain embodiments have been described and illustrated in exemplary forms with a certain degree of particularity, it is noted that the description and illustrations have been made by way of example only. Numerous changes in the details of construction, combination, and arrangement of parts and operations may be made. Accordingly, such changes are intended to be included within the scope of the disclosure, the protected scope of which is defined by the claims.

We claim:

1. A transportation vehicle for secure communications, the transportation vehicle comprising:
a vehicle chassis;
a communication system including a processor and a memory device, the processor executing instructions stored on the memory device to provide communication commands based on the executed instructions; and
a noise generation means for providing an audible noise signal as an alert that the transportation vehicle is near, wherein the audible noise signal includes embedded communications based on the communication commands from the communication system, wherein the embedded communications include a token having a signature to enable verification that the token remains unaltered.

2. The transportation vehicle of claim 1, wherein the token includes a payload for communication to one or more infrastructure devices.

3. The transportation vehicle of claim 2, wherein the payload includes payment information.

4. The transportation vehicle of claim 2, wherein the token is encrypted to conceal the payload from unauthorized access.

5. The transportation vehicle of claim 1, wherein the noise generation means includes a speaker for providing an audible noise.

6. The transportation vehicle of claim 5, wherein the speaker is a quiet mode device for providing constant audible noise during operation of the transportation vehicle in quiet modes.

7. The transportation vehicle of claim 1, wherein the noise generation means includes a sound receiver for receiving acoustic signals.

8. The transportation vehicle of claim 7, wherein the sound receiver receives inbound acoustic signals from one or more infrastructure devices and communicates the inbound acoustic signals to the communication system.

9. The transportation vehicle of claim 7, wherein the sound receiver includes a microphone.

10. A communication system for providing secure communications between a transportation vehicle and infrastructure, the communication system comprising:
a communication control system including a processor and a memory device, the processor executing instructions stored on the memory device to provide commands based on the executed instructions; and
a sound generator for providing an audible noise signal as an alert that the transportation vehicle is near, wherein the audible noise signal includes embedded communications based on the communication commands from the communication system, wherein the embedded communications include a token having a signature to enable verification that the token remains unaltered.

11. The communication system of claim 10, wherein the token includes a payload for communication to one or more infrastructure devices.

12. The communication system of claim 11, wherein the payload includes payment information.

13. The communication system of claim 11, wherein the token is encrypted to conceal the payload from unauthorized access.

14. The communication system of claim 10, wherein the sound generator includes a speaker for providing an audible noise.

15. The communication system of claim 14, wherein the speaker is a quiet mode device for providing constant audible noise during operation of the transportation vehicle in quiet modes.

16. The communication system of claim 10, wherein the sound generator includes a sound receiver for receiving acoustic signals.

17. The communication system of claim 16, wherein the sound receiver receives inbound acoustic signals from one or more infrastructure devices and communicates the inbound acoustic signals to the communication system.

18. The communication system of claim 17, wherein the sound receiver includes a microphone.

19. A method of providing secure communication for a transportation vehicle including a vehicle chassis and a communication system, the method comprising:
a processor executing instructions stored on a memory device coupled thereto to provide communication commands based on the executed instructions; and
the communication system generating one or more sound signals based on the communication commands using a sound generator,
wherein the one or more sound signals include a token having a signature enabling verification that the token remains unaltered.

20. The method of claim 19, wherein the token includes a payload for communication to one or more infrastructure devices.

21. The method of claim 20, wherein the payload includes payment information.

22. The method of claim 20, wherein the token is encrypted to conceal the payload from unauthorized access.

23. The method of claim 19, wherein the sound signals include acoustic frequencies.

24. The method of claim 19, wherein the sound generator is an e-sound device for providing an audible indication that the transportation vehicle is present.

25. The method of claim 19, wherein the sound generator includes a sound receiver for receiving sound signals.

26. The method of claim 25, wherein the sound receiver receives inbound sound signals from one or more infrastructure devices and communicates the inbound sound signals to the communication system.

27. The method of claim 26, wherein the sound receiver includes a microphone.
